(19) United States
(12) Patent Application Publication
(10) Pub. No.: US 2008/0142502 A1
(43) Pub. Date: Jun. 19, 2008

(54) Food preparation range with built-in cooking pots

(76) Inventors: Elias Bratcher, Miramar, FL (US); Deborah Bratcher, Miramar, FL (US)

Correspondence Address: IPA, STE. 101, 400 GARDEN CITY PLAZA, GARDEN CITY, NY, 11530, US

(21) Appl. No.: 11/640,372

(22) Filed: Dec. 18, 2006

(51) Int. Cl. H05B 3/68

(52) U.S. Cl. 219/450.1

(57) ABSTRACT

A food preparation range having built-in cooking pots and a detachable heated griddle is disclosed. The cooking pots are formed into the cooking surface of the top of the range. The range includes water fill and drain valves for each cooking pot. The built-in cooking pots are self cleaning. An oven or combination microwave oven is secured to the front wall of the range. The range includes a warming flap for keeping foods warm and a square slot depression adapted form frying foods such as chicken or fish.

### FIELD OF THE DISCLOSURE

The disclosures made herein relate generally to appliances for heating and preparing foods and, more particularly, to gas or electric pot-less ranges used in the cooking and preparation of food for human consumption wherein the range has an upper cooking surface having a plurality of cooking pots formed therein, eliminating the need for separate pots and pans.

### BACKGROUND

Various types of gas fired and electric ranges are well known in the art. Such ranges are typically equipped with a plurality of burners or electric heating elements. The burners or elements are sized to support widely used and available sizes of cooking pots and pans. While in wide use and popular, these ranges have a number of limitations. One, for example, it that conventional ranges require the use of separate pots and pans into which food is placed before cooking the food on the range. Space must be provided in the kitchen cabinets or other areas to store these pots and pans when not in use. Another limitation of conventional ranges is evident after the food has been prepared and it is time to clean the pots and pans. The user has to then endure the time consuming process of cleaning and scrubbing their dirty pots and pans. Still another limitation is that pots on a conventional range can be accidentally bumped or jarred from the burner, or in some cases can tip and spill, causing the pot and/or its contents to spill from the range with the danger of inflicting burns on the cook or nearby small children.

Therefore, it would be particularly advantageous if a cooking range were available that eliminated or minimized the limitations found in the current range designs.

### SUMMARY OF THE DISCLOSURE

Embodiments of the inventive disclosures herein comprise a gas or electric cooking range equipped with a plurality of built-in cooking pots, eliminating the need for separate pots and pans. The range has a base having opposing side walls connectively spanning between a front wall and a rear wall. The walls are interconnected to form a free standing rectangular range base. A cooking surface, often a substantially planar cooking surface, is secured to an upper portion of the range base. The cooking surface is provided with a plurality of cylindrical sidewall closed bottom depressions. Each depression forms a built-in cooking pot for containing and heating food items therein. Each cooking pot is formed into the planar cooking surface of the range. Each pot is provided with a drain hole in the closed bottom of the pot for the draining of liquids such as excess water from the pot. Each built-in cooking pot has at least one heating element for heating the pot and its contents for cooking, as well as a temperature sensor secured to a wall of the pot for detecting the temperature of the cooking pot and its contents. Each pot temperature sensor is electrically connected to an electronic digital controller provided on a backsplash of the range. Each pot also includes a non-stick coating for easy cleanup.

The range includes an oven contained within the range body in a fashion similar to conventional ranges. The oven is equipped with at least one heating element and preferably two heating elements, one being a broiler element and the other positioned near the bottom of the oven for baking. The oven also includes a temperature sensor electrically connected to the electronic digital controller. The oven heating elements are operably controlled by the digital controller. The range includes an oven door hingeably secured to the front wall of the range base, the oven door providing access to the interior of the oven as in conventional ranges. The range includes a back splash member positioned proximate to a top portion of the rear wall of the range base and extending upwards above the planar cooking surface so that is it generally facing the user of the range and positioned for visibility and accessibility by the user of the range. A storage drawer is built into the front wall of the range base.

The range includes an electronic digital controller with a, preferably illuminated, digital display secured to a front face of the back splash member. The controller is adapted to thermally control the heating of the cooking pots, oven heating elements and other heating elements as described later below. The controller is electrically connected to the temperature sensors in the cooking pots and oven thereby receiving the temperature of each cooking pot and the oven. The digital controller configured to display the temperature of each cooking pot and the oven temperature individually on the digital display. The electronic digital controller includes an automatic cooking timer for each built-in cooking pot, the timer settable to measure elapsed cooking time for each pot. The digital controller includes adjustable temperature controls to adjust the heating rate of each heating element. An electric strip light such as a fluorescent strip light or an incandescent strip light is secured to an upper portion of the back splash; the strip light is operable to illuminate the planar cooking surface.

The range further includes a plurality of cooking pot covers, at least one for each cooking pot. Each cooking pot cover is sized and adapted to be closeably and removeably received onto at least one of the built-in cooking pots.

In another aspect of the inventive disclosures herein, the electronic digital controller is built into the front wall of the range above the oven or microwave rather than in the backsplash.

In another aspect of the inventive disclosures herein, the built-in cooking pots are self cleaning, wherein the cooking pots are equipped and adapted to be strongly heated in a fashion similar to a self cleaning oven so as to carbonize and burn off remaining food remnants.

In another aspect of the inventive disclosures herein, the cooking pots include a light transmitting panel in the cylindrical sidewall of each cooking pot. The panel is adapted for conducting light from an illumination device secured within the range base so as to illuminate the interior of the pot and its contents.

In yet another aspect of the inventive disclosures herein, the planar cooking surface of the range includes a of grease plate holder secured proximate to the large built-in cooking pot.

In another aspect of the inventive disclosures herein, the range includes a square shaped heated depression in the planar cooking surface on the top of the range configured and adapted for frying fish or chicken. In a further aspect of the invention the square heated depression is approximately six inches by twelve inches with a depth of between six to eight inches.

In another aspect of the inventive disclosures herein, the range include a warming flap with a hinged rubber door, the warming flap is secured to the planar cooking surface. The hinged rubber door covers a heated depression into the planar cooking surface. In a further aspect of the invention the warming flap heated depression is approximately four inches deep by six inches wide.

In another aspect of the inventive disclosures herein, at least one cooking pot includes a drain valve characterized in having an open and a closed state, the drain valve state controllable by the electronic digital controller. The drain valve is in fluid communication with the drain hole of the cooking pot. At least one cooking pot also includes a water fill valve characterized in having an open and a closed state, the water fill valve controlled by the electronic digital controller. The water fill valve is secured to a portion of the cooking pot and adapted for selectively filling water into the cooking pot for preparing food. The cooking range further includes a water supply connection secured to the rear wall of the range, the water supply connection in fluid communication with the water fill valves of the pots. A drain connection is secured to the rear wall of the range, the drain connection is in fluid communication with the drain valves. At least one drain line is provided interconnecting the drain holes of the pots to the drain connection on the rear wall of the range.

In another aspect of the inventive disclosures herein, the electronic controller includes a fire sensor and alarm for detecting a cooking fire. The fire alarm is integrated to automatically shut off the heating elements of the range when a fire is detected.

In yet aspect of the inventive disclosures herein, the cooking range includes at least two tab holes provided in the planar cooking surface of the range. Electrical power supply and temperature sensor connections are provided within the tab holes. A heated griddle plate is provided and adapted to be removably securable to the planar cooking surface. The griddle plate includes an electric heating element secured to the griddle plate so as to heat a cooking surface of the griddle plate. A temperature sensor is secured to the griddle plate for detecting and reporting temperature to the digital controller. At least two mounting tabs are secured to the griddle plate, the tabs are sized and configured to removably secure the griddle plate to the cooking surface. The tabs are sized, positioned and adapted to be removably received into the tab holes in the cooking surface. The tabs are equipped with electrical connections for the griddle heating element and the griddle temperature sensor, the electrical connection on the tabs are sized and positioned to electrically mate with electrical connectors in the tab holes.

In another aspect of the inventive disclosures herein, the cooking range includes an AM/FM radio built into the back splash of the range.

In another aspect of the inventive disclosures herein, the cooking range includes a television receiver built into the back splash of the range.

In another aspect of the inventive disclosures herein, the cooking range includes a microwave oven built into an upper portion of the front wall of the range.

In another aspect of the inventive disclosures herein, the range has four cooking pots.

In another aspect of the inventive disclosures herein, the range is supplied for commercial cooking with a wider range with more than four built-in cooking pots.

In another aspect of the inventive disclosures herein, the range has four cooking pots wherein one is an eight inch diameter pot having a depression six inches deep, one is a six inch diameter pot having a depression four inches deep, one is a four inch diameter pot having a depression four inches deep and one is a four inch diameter pot having a depression three inches deep.

In another aspect of the inventive disclosures herein, the range is supplied for commercial cooking with a wider range with more than four built-in cooking pots.

In another aspect of the inventive disclosures herein, the cooking pot covers comprise any of copper, glass, aluminum, or stainless steel.

In another aspect of the inventive disclosures herein, the heating elements are electric heating elements and the range includes an attachment point for attaching a 240 volt AC supply to operate the range.

In another aspect of the inventive disclosures herein, the heating elements are gas heating elements and the range includes an attachment point for attaching a gas supply line to operate the range.

It is an objective of the inventive disclosure made herein to provide a range having cooking pots built into the top of the range.

It is another objective of the inventive disclosure made herein to provide a range in which the built-in cooking pots are self cleaning, removing the chore of cleaning pots and pans from the user.

It is another objective of the inventive disclosure made herein to provide a range which by design eliminates the accidental spillage of heated contents from a cooking pot or pan and thereby improves the safety of the range to the user of the range and others, particularly small children.

These and other objects of the invention made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 presents a perspective view of one embodiment of a cooking range in accordance with the inventive disclosures herein.

FIG. 2 presents a rear view of one embodiment of a cooking range in accordance with the inventive disclosures herein.

FIG. 3 presents a perspective view of one embodiment of a heated griddle adapted for removably mounting into the tab holes of the cooking range in accordance with the inventive disclosures herein.

FIG. 4 presents a side view of the planar cooking surface depicting a cooking pot secured to the cooking surface.

FIG. 5 depicts a cut away view of a cooking pot showing the heating element and drain hole.

FIG. 6 presents a perspective view of another embodiment of a cooking range in accordance with the inventive disclosures herein.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

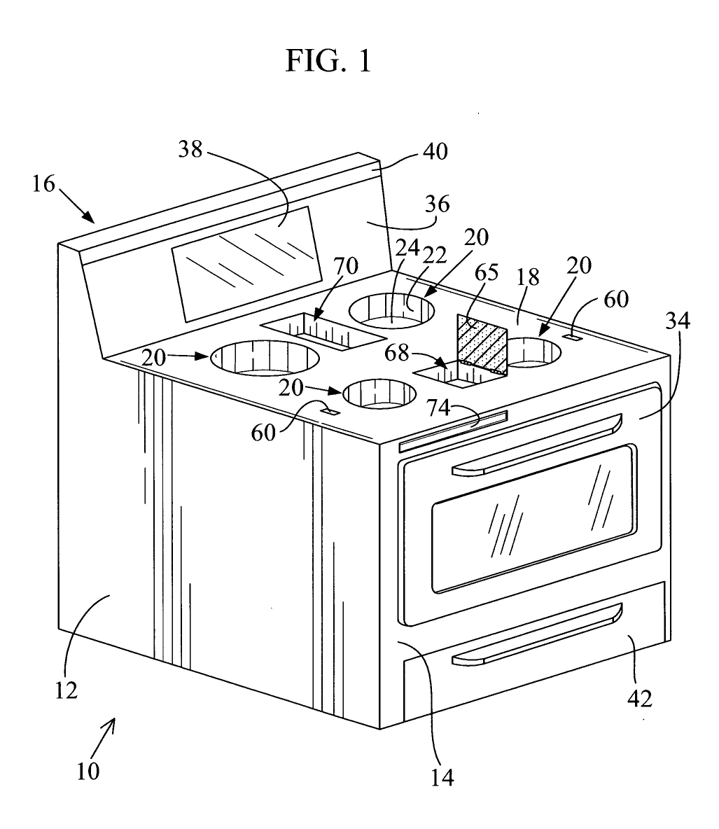

Turning now to FIGS. 1, 2, 3, 4, 5 and 6:

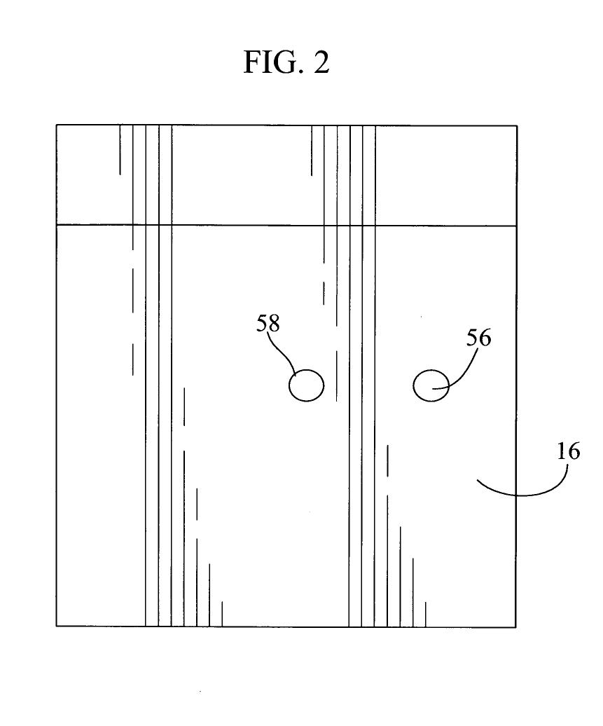

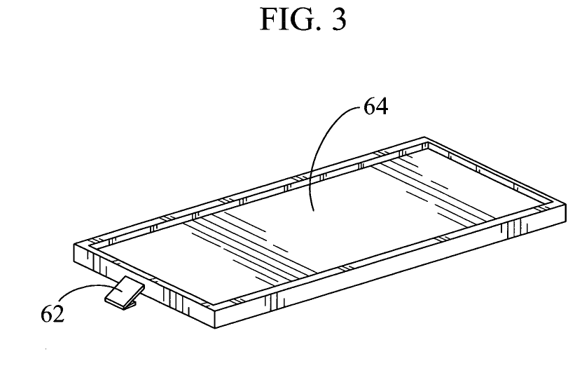

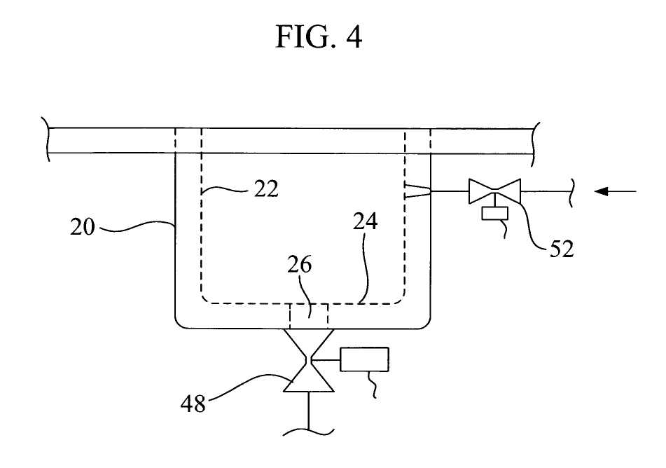

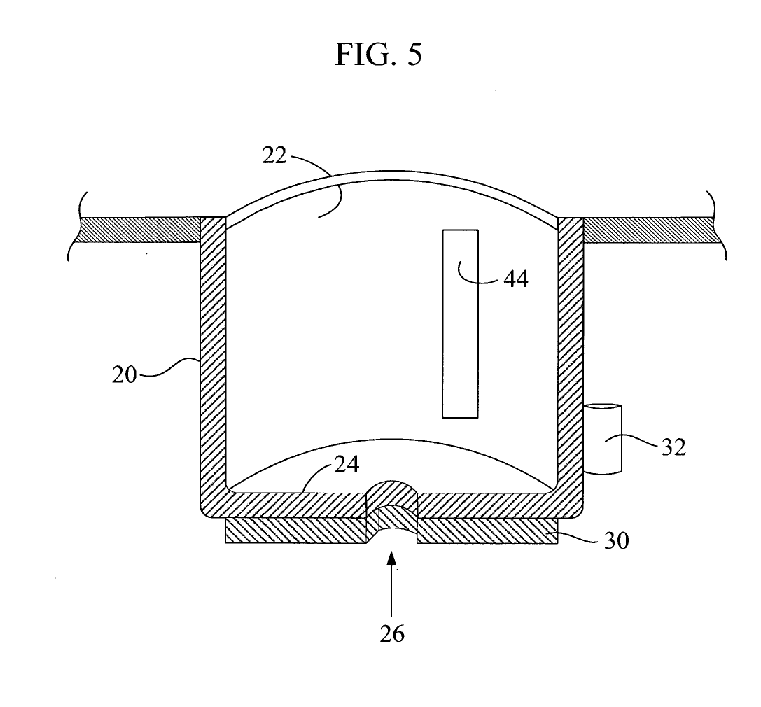

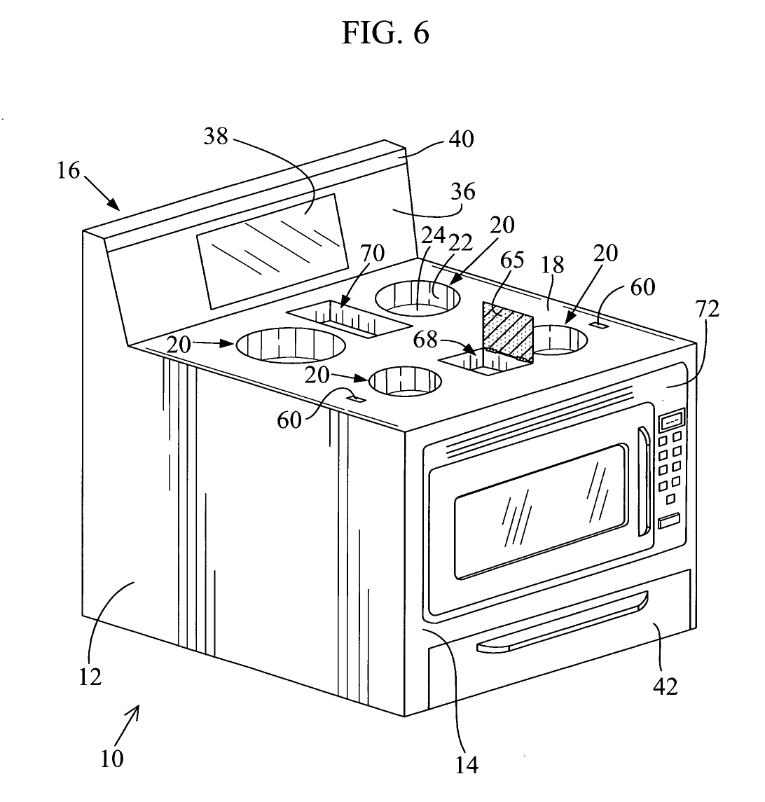

FIG. 1 presents a perspective view of one embodiment of a cooking range in accordance with the inventive disclosures herein. FIG. 2 presents a rear view of one embodiment of a cooking range in accordance with the inventive disclosures herein. FIG. 3 presents a perspective view of one embodiment of a heated griddle for removably mounting into the tab holes of the cooking range in accordance with the inventive disclosures herein. FIG. 4 presents a side view of the planar cooking surface depicting a cooking pot secured to the cooking surface. FIG. 5 depicts a cut away view of a cooking pot showing the drain hole and the heating element secured to the bottom of the pot. FIG. 6 presents a perspective view of another embodiment of a cooking range in accordance with the inventive disclosures herein. The cooking range 10 has a range base having side walls 12 connectively spanning between a front wall 14 and a rear wall 16. The range includes a substantially planar cooking surface 18 secured to an upper portion of the range base. The cooking surface 18 includes four built in cooking pots 20 each having a cylindrical sidewall 22 and closed bottom 24. Each cooking pot 20 is formed into the cooking surface 18. Each pot is equipped with a drain hole 26 in the closed bottom 24 of the pot 20. Each cooking pot has at least one heating element 30 secured to the pot for heating the pot and its contents for cooking. A temperature sensor 32, such as a thermocouple or an RTD, is secured to an outside wall of the pot 20. An oven is contained within the range base and has a door 34 hingeably secured to the front wall 14. A back splash member 36 is positioned proximate to a top portion of the rear wall 16 and extends upwards above the planar cooking surface 18. An electronic digital controller 38 with digital display and an input means such as a touch sensitive screen is secured to a front face of the back splash 36. The controller 38 is adapted to control the heating of the cooking pots 20 and oven heating elements (not shown). The controller 38 is electrically connected to the temperature sensors 32. The digital controller is configured to display the temperature of each cooking pot, griddle and the oven temperature individually on the digital display as well as the time of day and water level of each cooking pot 20. The controller 38 includes an automatic cooking timer for each pot as well as electronic temperature controls. An electric strip light 40 is secured to an upper portion of the back splash. The strip light is operable to illuminate the planar cooking surface 18. A storage drawer 42 is built into the front wall of the range base for storing cooking items. A light transmitting panel 44 is provided in the cylindrical sidewall 22 of each cooking pot 20, the panel for conducting light from an illumination device (not shown) secured within the range base to illuminate the interior of the pot and its contents. A television receiver may be included and secured with the electronic controller 38 in the backsplash.

Each cooking pot 20 has a drain valve 48 characterized in having an open and a closed state, the drain valve 48 state controllable by the electronic digital controller. The drain valve is in fluid communication with the drain hole 26 of the cooking pot 20. Each cooking pot 20 also has a water fill valve 52 characterized in having an open and a closed state, the water fill valve 52 is controllable by the electronic digital controller 38. The water fill valve is provided for selectively filling water into the cooking pot 20 for preparing food. A water supply connection 58 is secured to the rear wall 16 of the range 10, the water supply connection is in fluid communication with the water fill valves 52. A drain connection 56 is secured to the rear wall 16 of the range 10, the drain connection 56 is in fluid communication with the drain valves 48. Two tab holes 60 are provided in the planar cooking surface for receiving the tabs 62 of the heated griddle 64. The heated griddle plate is adapted to be removably securable to the planar cooking surface 18 and controlled by the controller 38.

A warming flap is built into the planar cooking surface 18. The warming flap comprises a rectangular heated depression 68 covered by a hinged rubber flap 65. The warming flap is operable for keeping prepared food warm. In a preferred embodiment the warming flap heated depression is approximately four inches deep by six inches wide.

A square shaped heated depression 70 in the planar cooking surface configured and adapted for frying fish or chicken. In a preferred embodiment the square heated depression is approximately six inches by twelve inches with a depth of between six to eight inches.

The electronic digital controller 38 may be built into the front wall 14 of the range above the oven 34 or microwave 72.

In FIG. 6 the oven is a combination convection heated oven and microwave oven 72.

The discussed construction, illustrations and sequence of operation is for one embodiment of the invention, but is in no way limiting to other embodiments. The operating modes may be changed and enhanced without deviating from the intention of this inventive disclosure.

In the preceding detailed description, reference has been made to the accompanying drawings that form a part hereof, and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A food preparation range with built in cooking pots, comprising:
a range base having opposing side walls connectively spanning between a front wall and a rear wall, the range base comprising:
a substantially planar cooking surface secured to an upper portion of the range base, the cooking surface having a plurality of cylindrical sidewalled closed bottom depressions, each depression forming a built-in cooking pot, each cooking pot formed into the planar cooking surface, each pot having a drain hole in the closed bottom of the pot, each built-in cooking pot comprising:
at least one heating element for heating the pot and its contents for cooking;
a temperature sensor secured to an outside wall of the pot, the sensor for detecting the temperature of the contents of the pot, the temperature sensors electrically connect to an electronic digital controller; and
a non-stick coating secured to interior sidewalls and bottom of the pot;
an oven contained within the range base, the oven having at least one heating element, the oven having a temperature sensor electrically connected to the electronic digital controller, the heating elements operable and controlled by the digital controller;
an oven door hingeably secured to the front wall, the oven door providing access to the interior of the oven;
a square shaped heated depression secured to the planar cooking surface, the heated depression configured and adapted for frying foods such as fish or chicken;
a warming flap with a hinged rubber door, the warming flap secured to the planar cooking surface, the warming flap comprising:
a rectangular heated warming depression; and
a hinged rubber door covering the heated warming depression;
a back splash member positioned proximate to a top portion of the rear wall and extending upwards above the planar cooking surface;
the electronic digital controller with digital display secured to the range, the controller adapted to control the heating of the cooking pots and oven heating elements, the controller electrically connected to the temperature sensors, the digital controller configured to display the temperature of each cooking pot and the oven temperature individually on the digital display, the controller comprising:
an automatic cooking timer for each pot, the timer settable to measure elapsed cooking time for each pot; and
electronic temperature controls to adjust heating rate of each heating element;
an electric strip light secured to an upper portion of the back splash, the strip light operable to illuminate the planar cooking surface;
a storage drawer built into the front wall of the range base; and
a plurality of cooking pot covers, at least one for each cooking pot, each cover sized and adapted to be closeably and removably received onto the cooking pot.

2. The cooking range of claim 1, wherein the cooking pots are self cleaning, the cooking pots equipped and adapted to be selectively and strongly heated so as to carbonize and burn off remaining food remnants.

3. The cooking range of claim 2, wherein the cooking pots further comprise:
a light transmitting panel in the cylindrical sidewall of each cooking pot, the panel for conducting light from an illumination device secured within the range base to illuminate the interior of the pot and contents.

4. The cooking range of claim 3, further comprising:
At least one of grease plate holder positioned on the planar cooking surface proximate to its related cooking pot.

5. The cooking range of claim 4, wherein
the cooking pots further comprise:
a drain valve characterized in having an open and a closed state, the drain valve state controllable by the electronic digital controller, the drain valve in fluid communication with the drain hole of the cooking pot; and
a water fill valve characterized in having an open and a closed state, the water fill valve controllable by the electronic digital controller, the water fill valve secured to a portion of the cooking pot for selectively filling water into the cooking pot for preparing food; and
wherein the cooking range further comprises:
a water supply connection secured to the rear wall of the range, the water supply connection in fluid communication with the water fill valves;
a drain connection secured to the rear wall of the range, the drain connection in fluid communication with the drain valves; and
at least one drain line interconnecting the drain holes of the pots to the drain connection.

6. The cooking range of claim 5, wherein the electronic controller further comprises:
a fire sensor and alarm for detecting a cooking fire, the fire alarm integrated to automatically shut off the heating elements of the range when a fire is detected.

7. The cooking range of claim 4, further comprising
at least two tab holes provided in the planar cooking surface;
electrical power supply and temperature sensor connections provided in the tab holes;
a heated griddle plate adapted to be removably securable to the planar cooking surface, the griddle plate comprising:
an electric heating element secured to the griddle plate;
a temperature sensor secured to the griddle plate; and
at least two mounting tabs secured to the griddle plate, the tabs sized and configured to removably secure the griddle plate to the cooking surface, the tabs sized, positioned and adapted to be removably received into the tab holes, the tabs having electrical connections for the griddle heating element and the griddle temperature sensor, the electrical connection on the tabs sized and positioned to electrically mate with electrical connectors in the tab holes.

8. The cooking range of claim 7, further comprising an AM/FM radio built into the back splash of the range.

9. The cooking range of claim 7, further comprising a television receiver built into the back splash of the range.

10. The cooking range of claim 7, wherein the range has four cooking pots.

11. The cooking range of claim 7, wherein the cooking pot covers comprise any of copper, glass, aluminum, or stainless steel.

12. The cooking range of claim 11, wherein the cooking pots have the following dimensions:
one eight inch diameter pot having a depression six inches deep;
one six inch diameter pot having a depression four inches deep;
one four inch diameter pot having a depression four inches deep; and
one four inch diameter pot having a depression three inches deep.

13. The cooking range of claim 7, wherein the heating elements are electric heating elements and the range includes an attachment point for attaching a 240 volt AC supply to operate the range.

14. The cooking range of claim 7, wherein the heating elements are gas heating elements and the range includes an attachment point for attaching a gas supply line to operate the range.

15. The cooking range of claim 7, wherein the oven is a combination heatec oven and microwave oven.

16. The cooking range of claim 7, wherein the electronic control is secured to the backspash.

17. The cooking range of claim 7, wherein the electronic control is secured to the front wall of the range.

18. The cooking range of claim 7, wherein the range is configured for commercial cooking applications.
